(19) United States
(12) Patent Application Publication
(10) Pub. No.: US 2008/0166204 A1
(43) Pub. Date: Jul. 10, 2008

(54) FASTENING DEVICE AND METHOD OF FABRICATING THE SAME

(76) Inventor: Martin J. Nilsen, Hampshire, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/873,732

(22) Filed: Oct. 17, 2007

Related U.S. Application Data
(60) Provisional application No. 60/878,739, filed on Jan. 5, 2007.

(51) Int. Cl. F16B 27/00; B28B 1/24

(52) U.S. Cl. 411/378; 264/645; 411/427

(57) ABSTRACT

A fastener includes a fastener body with a peripheral surface that is configured to be received in a mold assembly. The body is divided into an encased portion and an exposed portion. The encased portion is configured to be surrounded by molding material. The exposed portion is configured to be void of molding material. A crush rib extends along at least a portion of the peripheral surface at an interface between the encased portion and the exposed portion.

### CROSS REFERENCE TO RELATED APPLICATION

This Non-Provisional Application claims benefit to U.S. Provisional Application Ser. No. 60/878,739 filed on Jan. 5, 2007, the complete subject matter of which is expressly incorporated herein in its entirety.

### BACKGROUND OF THE INVENTION

The present invention relates generally to fasteners, such as a nut, and more particularly to fasteners that are to be placed into a mold assembly.

A molding material, such as plastic, may be molded under high temperature and pressure using an injection molding machine. The molding material typically fills-out all the details of a typical part inserted into the mold assembly. For example, a fastener, such as a nut, may be placed into a known mold assembly that includes two separable mold halves that are clamped together to encase the fastener. The mold assembly is positioned in the injection molding machine. The molding material is then injected into the mold assembly and flows around the nut to capture the nut.

During the injection process, the mold assembly should clamp to the nut with sufficient force to stop the flow of the molding material beyond the mold assembly. However, high molding pressures may cause stresses at an interface between the nut and the mold assembly to be higher than the applied molding pressure. As such, the surface area at the interface may have a greater pressure per square inch compared to the applied molding pressure.

In order to achieve a positive shut-off, known molds have relatively large surface areas contacting the nut to prevent the molding material from leaking through the interface. The relatively large surface areas require the injection molding machine to apply an increased pressure to the mold assembly to clamp the mold closed. This increased pressure may cause the fastener to deform during the injection molding process.

For example, FIG. 1 illustrates an example of a commercially available fastener 1 (e.g., a nut) that is used as an insert in a known mold assembly 2. During fabrication, an injection molding machine (not shown) may have difficulty in shutting off on the fastener. Specifically, the injection molding machine may have difficulty closing the mold assembly 2 such that a proper seal is formed at the interface or shut-off area 3 between the mold assembly 2 and the fastener 1. The failure of the interface 3 may result in excess molten plastic 4 leaking or squirting past the interface area 3 into unwanted areas, such as the threads 5 of the fastener 1 which may result in problems during any assembly using the nut. The excess plastic may also cause, re-work, scrap, and waste in general. Typically, the cause of the poor shut-off is based on an amount of pressure the injection molding machine may exert onto the fastener. However, further increasing the pressure on the mold assembly may cause the fastener to distort.

A need remains for a fastener having a reliable interface that is configured to facilitate the formation of a seal between the mold assembly and the fastener.

### BRIEF DESCRIPTION OF THE INVENTION

In one embodiment, a fastener is provided that includes a fastener body having a peripheral surface configured to be received in a mold assembly. The body is divided into an encased portion and an exposed portion. The encased portion is configured to be surrounded by a molding material and the exposed portion is configured to be void of the molding material. A crush rib extends along at least a portion of the body at an interface between the encased portion and the exposed portion. The crush rib is configured to be sealably engaged by the mold assembly during a molding process.

In another embodiment, a fastener is provided that includes a body having a peripheral surface. The body also includes a first load bearing surface and an opposite second load bearing surface. The peripheral surface extends between the first and second load bearing surfaces. A first crush rib is disposed on the first load bearing surface. The first crush rib is configured to deform such that a seal is formed between the body and a mold assembly.

In a further embodiment, a method of injection molding utilizing a mold assembly is provided. The method includes inserting a fastener into the mold assembly. The fastener includes a fastener body and a crush rib. The fastener body has a peripheral surface configured to be received and securely retained in the mold assembly. The body is divided into an encased portion and an exposed portion. The method further includes closing the mold assembly with sufficient force to at least partially deform the crush rib, and injecting a molding material into the mold assembly such that the molding material substantially surrounds the encased portion and such that the crush rib prevents the molding material from contacting the exposed portion.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 illustrates a known device depicting a steel nut surrounded by plastic as currently known in the prior art.

FIG. 2 is a perspective view of an exemplary fastener formed in accordance with an embodiment of the present invention.

FIG. 3 is a side view of the fastener shown in FIG. 2 taken along lines 3-3 in FIG. 2.

FIG. 4 is a top view of the fastener shown in FIG. 2.

FIG. 5a illustrates the fastener shown in FIG. 2 inserted into a mold assembly in accordance with an embodiment of the present invention.

FIG. 5b illustrates the fastener shown in FIG. 5a deformed under pressure in accordance with an embodiment of the present invention.

FIG. 6 illustrates an exemplary method of injection molding utilizing a mold assembly in accordance with an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

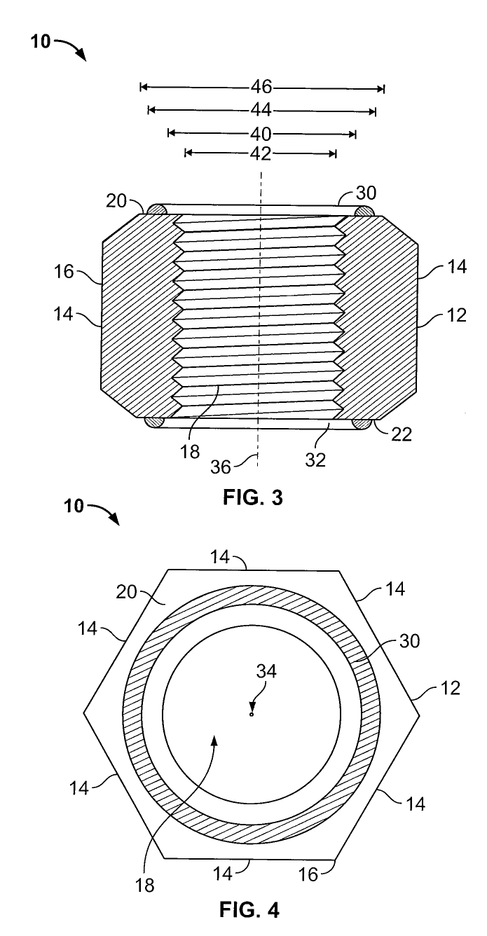

FIG. 2 is a perspective view of an exemplary fastener 10. FIG. 3 is a cross-sectional view of the fastener 10 shown in FIG. 2 taken along lines 3-3 in FIG. 2. FIG. 4 is a top view of the fastener 10 shown in FIG. 2. In the exemplary embodiment, fastener 10 is a hexagonal nut that includes a body 12 having a plurality of outer side surfaces 14. The outer side surfaces 14 form an overall peripheral surface 16 that is generally hexagonal in shape and configured to be encased within a plastic assembly as will be discussed below. The body 12 also includes a threaded opening 18 for engagement with a bolt (not shown). The body further includes opposed load bearing end surfaces 20 and 22. As shown in FIG. 3, the opposed load bearing end surfaces 20 and 22 are generally perpendicular to outer side surfaces 14.

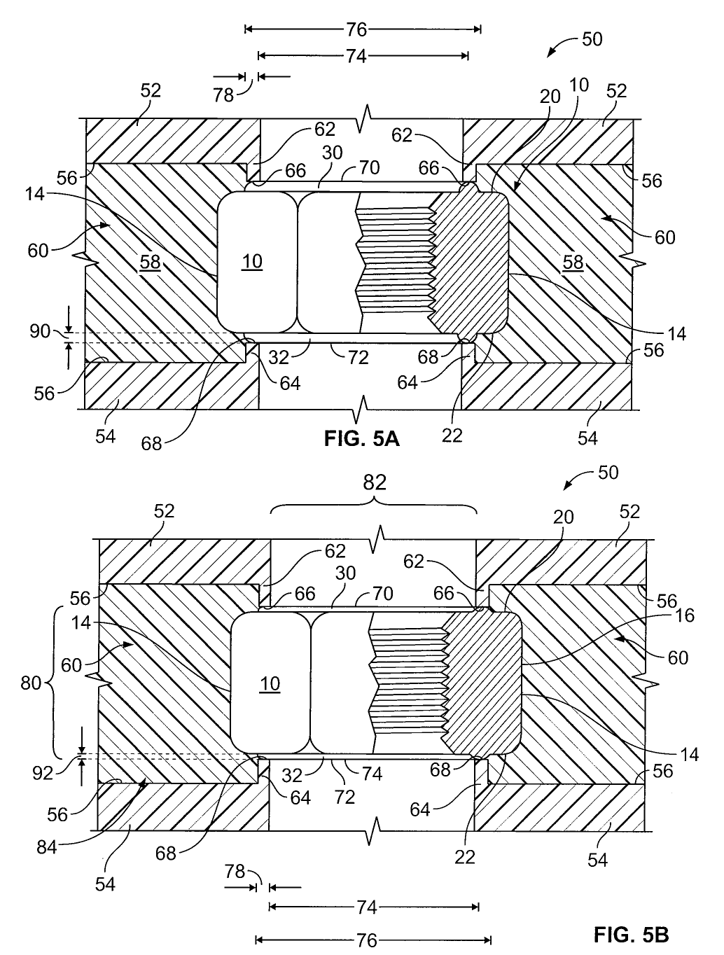

As used herein, a load bearing surface represents a surface of a fastener that interfaces with a mold assembly to form a seal. For example, during operation, an injection molding machine (not shown) applies pressure to a mold assembly to facilitate forming a seal between the mold assembly and the load bearing surfaces of a fastener. FIGS. 2-4 illustrate an exemplary fastener 10 that may be utilized with an exemplary mold assembly shown in FIG. 5. It should be understood that fastener 10 is exemplary only and is not limited in its application to the details of construction and the arrangement of the components set forth in the following description or illustrated in the drawings. For example, fastener 10 may be a bolt, a screw, an Allen screw, a threaded insert, etc.

Fastener 10 also includes a crush rib 30 that is coupled to, or formed with, load bearing end surface 20. In the exemplary embodiment, fastener 10 also includes a crush rib 32 that is coupled to, or formed with, load bearing end surface 22. Each of the crush ribs 30 and 32 has a substantially annular shape having a center 34 (shown in FIG. 4) that is concentric with a centerline axis 36 of threaded opening 18 (shown in FIG. 3). Optionally, crush ribs 30 and/or 32 may have a shape that is substantially similar to each of the respective load bearing end surfaces 20 and 22. For example, in this case, crush ribs 30 and 32 may have a substantially hexagonal shape. Moreover, each of crush ribs 30 and 32 has an inner diameter 40 that is greater than an outer diameter 42 of threaded opening 18, and an outer diameter 44 of crush ribs 30 and 32 is less than an outer diameter 46 of each respective load bearing end surface 20 and 22. Accordingly, each of crush ribs 30 and 32 circumscribes threaded opening 18.

As shown in FIG. 3, each of the crush ribs 30 and 32 has a substantially semi-circular cross-sectional profile. Moreover, the surface area of each of crush ribs 30 and 32 is less than the surface area of each respective load bearing end surface 20 and 22. As such, the smaller surface area of the crush ribs 30 and 32 facilitates reducing the load pressure applied to the fastener 10 during the injection molding process, while still attaining a positive shutoff between the mold assembly and fastener 10.

To fabricate fastener 10, body 12 is cast from a metallic material such as stainless steel, for example. Optionally, the body 12 may be cast using a variety of metallic materials or plastic. In the exemplary embodiment, body 12 is cast or fabricated using a cold forming process to include crush ribs 30 and 32. Specifically, in this embodiment, crush ribs 30 and 32 are formed unitarily with body 12 and fabricated using the same material. In another embodiment, the crush ribs 30 and 32 may be fabricated from a material that is different than the material that is used to fabricate body 12. For example, if body 12 is fabricated using a stainless steel material, the crush ribs 30 and 32 may be fabricated from a softer material such as plastic, and then affixed to body 12 using an adhesive.

As discussed above, the crush ribs 30 and 32 are fabricated to deform at a pressure that is less then pressure required to deform body 12. For example, body 12 may begin to deform when a predetermined amount of pressure is applied by the injection molding machine (e.g. X foot/pounds or pounds/square inch). To reduce and/or eliminate the deformation of body 12, the crush ribs 30 and 32 are configured to deform when a desired amount of pressure is applied by the injection molding machine (e.g. Y foot/pounds or pounds/square inch). As such, when the desired amount of pressure is applied to fastener 10, crush ribs 30 and 32 are configured to deform at a pressure that is less than the pressure required to deform body 12.

FIG. 5a is a cross-sectional view of fastener 10 encased within an exemplary mold assembly 50. FIG. 5b is a cross-sectional view of fastener 10 encased within an exemplary mold assembly 50 illustrating crush ribs 30 and 32 deformed when pressure is applied. As shown in FIGS. 5a and 5b, mold assembly 50 includes a pair of separable mold halves 52 and 54. During the injection molding process, fastener 10 is secured within the injection molding machine using the mold halves 52 and 54. As shown in FIG. 5a, fastener 10 is inserted into the mold halves 52 and 54, and the mold halves 52 and 54 are clamped together using the injection molding machine. As shown in FIG. 5b, the injection molding machine exerts pressure on mold assembly 50 causing the crush ribs 30 and 32 to deform and thus form a seal between fastener 10 and mold assembly 50.

The mold assembly 50 has an interior surface 56 that forms a cavity 58 that is configured to receive a molding material 60, e.g. the molten plastic encasing fastener 10. Each mold half 52 and 54 includes a shut-off device 62 and 64, respectively, that is configured to contact the respective crush ribs 30 and 32. Specifically, each shut-off device 62 and 64 includes a contact surface 66 and 68 that is sized to seat against a contact surface 70 and 72 formed on each respective crush ring. As such, each shut-off device 62 and 64 has shape that is substantially similar to the shape of each respective crush rib 30 and 32. For example, in this embodiment, each crush rib 30 and 32 has a substantially annular shape, therefore each respective shut-off device 62 and 64 has a substantially annular shape to enable each shut-off device 62 and 64 to form a complete seal with each respective crush rib 30 and 32.

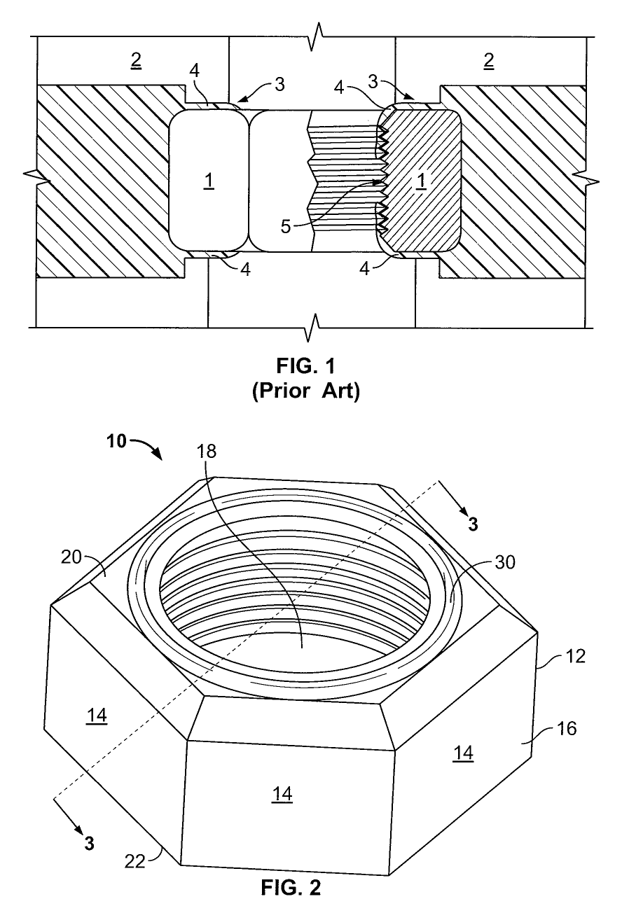

Each shut-off device 62 and 64 has an inner diameter 74 that is approximately equal to the inner diameter 40 (shown in FIG. 2) of crush ribs 30 and 32. Each shut-off device 62 and 64 also has an outer diameter 76 that is approximately equal to the outer diameter 44 (shown in FIG. 2) of crush ribs 30 and 32. Since the outer diameter of each of crush ribs 30 and 32 and shut-off devices 62 and 64 is less than the outer diameter 46 of the respective load bearing end surfaces 20 and 22, a width 78, represented as a distance between the inner and outer diameters 74 and 76, of shut-off devices 62 and 64 is less than a width of the known shut-off devices shown in FIG. 1.

For example, referring again to FIG. 1, the width of the known shut off devices is approximately equal to the distance represented between the threaded opening and the outer side surfaces of the known fastener. However, in this embodiment, the width 78 of the shut-off devices 62 and 64 is less than the width of known shut-off devices, thus the contact surface area of shut-off devices 62 and 64 is less than the contact surface area of known shut-off devices enabling the molding machine to close mold assembly 50 on fastener 10 using less pressure than known mold assemblies.

During fabrication, as shown in FIG. 5b, the mold halves 52 and 54 are generally divided into an encased portion 80 and an exposed portion 82. The encased portion 80 is generally represented as that portion of fastener 10 that is designated to be encased in the molding material, whereas exposed portion 82 is generally represented as that portion of fastener 10 that is designated to be void of the molding material, such as threaded opening 18, for example. As shown in FIG. 5b, the crush ribs 30 and 32 are configured to form the boundary between encased portion 80 and exposed portion 82. More specifically, the encased portion 80 has a peripheral surface 84 that is confined within interior surface 56 of cavity 58 and forms the boundary between the molding material and the body 12. As shown in FIG. 5b, the peripheral surface 84 includes the outer side surfaces 14, and a portion of the load bearing end surfaces 20 and 22 that extend between the outer side surfaces 14 and the threaded opening 18. As such, crush ribs 30 and 32 are formed along a least a portion of the peripheral surface 84 and function as an interface or shut-off zone between the encased portion 80 and the exposed portion 82.

As shown in FIG. 5a, crush ribs 30 and 32 each have a thickness 90 that represents the thickness of each respective crush rib prior to be deformed within mold assembly 50. As shown in FIG. 5b, when pressure is applied to mold assembly 50, each respective shut-off device 62 and 64, is forced against a respective crush rib 30 or 32 causing the crush rib to deform. Specifically, each shut-off device 62 and 64 “crushes” a respective crush rib 30 or 32 to facilitate forming a seal between mold assembly 50 and fastener body 12. As a result, each crush rib 30 and 32 has a thickness 92 that is representative of the deformed thickness of each crush rib 30 and 32 after force is applied by the injection molding machine. As shown in FIG. 5b thickness 92 is less than thickness 90 indicating that the crush ribs have been deformed by an applied pressure.

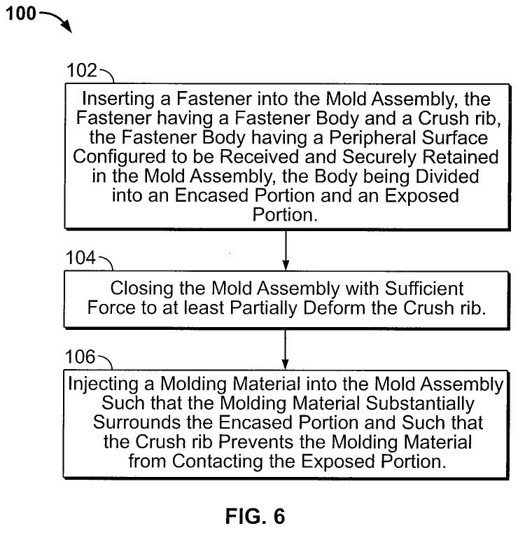

FIG. 6 is a flowchart illustrating a method 100 of injection molding utilizing a mold assembly 50. The method includes inserting 102 a fastener 10 into the mold assembly 50, the fastener 10 having a fastener body 12 and a crush rib 30 and/or 32, the fastener body 12 having a peripheral surface 16 configured to be received and securely retained in the mold assembly 50. The body 12 is divided into an encased portion 80 and an exposed portion 82. Method 100 further includes closing 104 the mold assembly 50 with sufficient force to at least partially deform the crush rib 30 and/or 32, and injecting 106 a molding material into the mold assembly 50 such that the molding material substantially surrounds the encased portion 80 and such that the crush rib 30 and/or 32 prevents the molding material from contacting the exposed portion 82.

For example, during operation, the crush ribs 30 and 32 are configured to deform during the molding process to form a seal between mold assembly 50 and fastener 10. Specifically, the crush ribs 30 and 32 are configured to plastically deform to form a leak-proof seal when the two injection mold halves of mold assembly 50 are closed during the molding process. The crush ribs 30 and 32 therefore compensate for any misalignment in mold assembly 50. Moreover, the crush ribs 30 and 32 compensate for any lack of flatness in the mold assembly 50 by providing a positive surface to surface connection between the mold assembly 50 and the crush ribs 30 and 32.

Crush ribs 30 and 32 enable the injection molding machine to form a seal against fastener 10 with a predetermined level of force or pressure XX to overcome a predetermined level of molding pressure YY. Additionally, crush ribs 30 and 32 have a relatively small surface area that facilitates reducing the amount of load that is required to be exerted by the injection molding machine to attain a predetermined required level of stress that prevents the flow of the molding material from leaking during the molding process.

Described herein is a fastener that includes at least one crush rib that provides a reliable interface that is configured to “shut-off” the flow of the molding material with less pressure applied to the fastener. Specifically, the crush ribs inhibit the flow of molding material beyond the crush ribs. Moreover, the reduced surface area of the crush ribs compared to the surface area of the load bearing surfaces, reduces an amount of force necessary for a positive shut-off. As such, the crush ribs have a small surface area compared to what is commercially available for an interface between a molding apparatus and a typical fastener. Furthermore, the crush ribs are capable of being deformed during a molding process to facilitate the formation of a seal within the mold assembly. Therefore, since a reduced amount of pressure is required to form a seal between the mold assembly and the fastener because the crush ribs are capable of being deformed during the molding procedure, the fastener is not distorted.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A fastener comprising:
a fastener body with a peripheral surface configured to be received in a mold assembly, the body being divided into an encased portion and an exposed portion, the encased portion configured to be surrounded by molding material and the exposed portion configured to be void of molding material; and
a crush rib extending along at least a portion of the body at an interface between the encased portion and the exposed portion, the crush rib being configured to be sealably engaged by a mold assembly during a molding process.

2. The fastener in accordance with claim 1, wherein the crush rib is deformed during the molding process to facilitate formation of a seal within the mold assembly.

3. The fastener in accordance with claim 1, wherein the crush rib is formed unitarily with the fastener body.

4. The fastener in accordance with claim 1, wherein the fastener has a threaded opening and the crush rib circumscribes the threaded opening.

5. The fastener in accordance with claim 1, wherein the crush rib has a width that is approximately equal to a width of a mold assembly shut-off device.

6. The fastener in accordance with claim 1, wherein the crush rib has an annular profile and the mold assembly includes an annular shut-off device to deform the crush rib.

7. The fastener in accordance with claim 1, wherein the crush rib provides a positive surface to surface connection between the mold assembly and the fastener body.

8. The fastener in accordance with claim 1, wherein the crush-rib seals the mold assembly interface with a predetermined level of load to overcome a predetermined level of molding pressure.

9. The fastener in accordance with claim 1, further comprising a second crush rib, the first crush rib is located at a first end of the fastener body along a first peripheral surface and the second crush rib is located at a second end of the fastener body along a second peripheral surface.

10. The fastener in accordance with claim 1, wherein the fastener comprises at least one of a nut, a bolt, and a screw.

11. A fastener comprising:
a fastener body comprising a peripheral surface, the peripheral surface having at least a first load bearing surface and an opposite second load bearing surface; and
a first crush rib disposed on the peripheral surface, the first crush rib is configured to deform such that a seal is formed between the fastener body and a mold assembly.

12. The fastener in accordance with claim 11, further comprising a second crush rib disposed on the second load bearing surface, the second crush rib is configured to deform such that a seal is formed between the fastener body and the mold assembly.

13. The fastener in accordance with claim 12, wherein the first and second crush ribs are configured to deform when subjected to a first pressure that is less than a second pressure required to deform the body.

14. The fastener in accordance with claim 12, wherein the first and second crush ribs are formed unitarily with the fastener body.

15. A method of injection molding utilizing a mold assembly, the method comprising:
inserting a fastener into the mold assembly, the fastener having a fastener body, the fastener body having a peripheral surface configured to be received and securely retained in the mold assembly, the body being divided into an encased portion and an exposed portion;
closing the mold assembly with sufficient force to at least partially deform a crush rib formed on the body; and
injecting a molding material into the mold assembly such that the molding material substantially surrounds the encased portion and such that the crush rib prevents the molding material from contacting the exposed portion.

16. The method in accordance with claim 15, further comprising closing the mold assembly to plastically deform the crush rib to form a leak-proof seal when a pair of mold halves close during the injection molding process.

17. The method in accordance with claim 15, wherein the fastener further includes a second crush rib disposed at an opposite end of the body, the method further comprising closing the mold assembly with sufficient force to at least partially deform the first and second crush ribs.

18. The method in accordance with claim 15, further comprising closing the mold assembly with sufficient force to at least partially deform the crush rib such that the crush rib accommodates any misalignment in the mold assembly, and such that the crush rib accommodates any lack of flatness at the interface between the mold assembly and the body.

19. The method in accordance with claim 16, further comprising closing the mold assembly with sufficient force to at least partially deform the crush rib such that the crush rib provides a positive surface to surface connection between the mold assembly and the crush rib.

20. The method in accordance with claim 16, further comprising applying a predetermined level of pressure to the crush rib to overcome a predetermined level of molding pressure to seal the interface between the fastener body and the mold assembly.
